(19) United States
(12) Patent Application Publication
(10) Pub. No.: US 2005/0188095 A1
(43) Pub. Date: Aug. 25, 2005

(54) System for managing server user operation sessions

(76) Inventors: Jeffrey Gardiner, Phoenixville, PA (US); Domonic Snyder, Whitehall, PA (US); Christopher Gardner, Charlotte, NC (US); William Boggs, Acworth, GA (US)

Correspondence Address: Alexander J. Burke;Intellectual Property Department, 5th Floor, 170 Wood Avenue South, Iselin, NJ, 08830, US

(21) Appl. No.: 10/852,885

(22) Filed: May 25, 2004

Related U.S. Application Data
(60) Provisional application No. 60/545,802, filed on Feb. 19, 2004.

(51) Int. Cl. G06F 15/167; G06F 15/16

(52) U.S. Cl. 709/230; 709/203

(57) ABSTRACT

A system automatically seizes a session that is actively connected to a device and attaches it to a different device. A system manages user operation sessions on a plurality of servers. The system includes an interface for receiving, from a first workstation, a request to initiate a current session of operation of a particular executable application on a first server and user identification information from a particular user. In response to the received particular user identification information, a session processor identifies an active session of operation of the particular user on a second server previously initiated via a second workstation and re-attaches connection of the previously initiated active session of operation to the first workstation as the current session.

This is a non-provisional application of provisional application Ser. No. 60/545,802 by D. Snyder filed Feb. 19, 2004.

### FIELD OF THE INVENTION

This invention concerns a system for managing user operation sessions on one or more servers to reduce redundant sessions and improve security.

### BACKGROUND OF THE INVENTION

A user may connect to different applications executing on the same or different servers from one or more workstations at different locations. If a user roams from one location to another in this manner without properly disconnecting a session of operation, the session remains “active”. In existing systems, when a user connects to a server from a new location, a new session is created even though there is a concurrent previously created operation session. The reason for this is that the previously created session is in an “active” rather than “disconnected” state. Therefore there are two “active” sessions associated with the user. If this goes on repeatedly a user will create many concurrent “active” sessions of computer operation. This is undesirable because multiple sessions consume server resources and represent a potential security problem. Also, a user that initiates a second concurrent session may need to engage in burdensome navigation to return to a previous position achieved in a first session to continue work tasks using an application. A system according to invention principles addresses these problems and related problems.

### SUMMARY OF THE INVENTION

A system automatically re-directs a session that is actively connected to a device and attaches it to a different device. A system manages user operation sessions on a plurality of servers. The system includes for receiving, from a first workstation, a request to initiate a current session of operation of a particular executable application on a first server and user identification information from a particular user. In response to the received particular user identification information, a session processor identifies an active session of operation of the particular user on a second server previously initiated via a second workstation and re-attaches connection of the previously initiated active session of operation to the first workstation as the current session.

### BRIEF DESCRIPTION OF THE DRAWING

FIG. 1 shows a block diagram of a system for managing user operation sessions on one or more different-servers, according to invention principles.

FIG. 2 shows a flowchart of a process used in the system of FIG. 1 for managing user operation sessions on one or more different servers, according to invention principles.

FIG. 3 shows a flowchart of a process used to identify and re-connect to previous user operation sessions, according to invention principles.

### DETAILED DESCRIPTION OF INVENTION

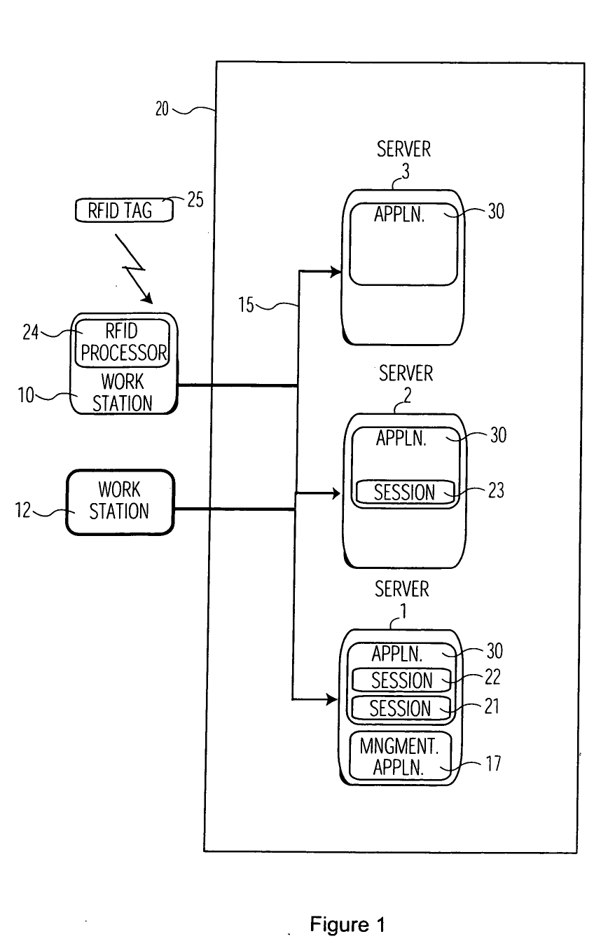

FIG. 1 shows a block diagram of a system for managing user operation sessions on one or more different servers. A session of operation, as used herein, includes a session of operation of an executable application or procedure or a session of operation of a processing device such as a workstation, PC, server, microprocessor, controller or portable processing device. As used herein, a “disconnected session” is an “orphaned” session having no client work stations connected with the session and an “active session” is a user session that does have a client work station connected with the session. Existing systems fail to comprehensively address session management in an environment in which a user creates a new session and has a previously created “active session”. One known system reconnects a current user worksation to a previous “disconnected session” if a user logs on and connects to a server and a previously disconnected session initiated by the user exists. However, known systems fail to manage reconnection in the event that a user has a previous “active session” of operation. A system, according to invention principles, manages user operation sessions on a plurality of servers and enables users of a server (such as Citrix's current MetaFrame products (v 1.8 and XP), for example) to seize a session that is actively connected to another device and attach it to a different device.

The system allows a user (such as a physician or another) to roam from one location to another (home to office; patient room to patient room; etc.) and have an active session follow the user, for example. The session returns to a position in an application (such as a particular displayed image) where a user left off at a previous location. The system addresses the situation where a user creates and abandons one or more active sessions throughout the course of a day, for example. The system advantageously reduces server overhead with roaming users by eliminating multiple sessions per user and improves security by eliminating abandoned sessions. The system also advantageously eliminates the need for a user to reestablish a session from scratch when an active session already exists elsewhere in a group of servers, for example.

An executable application as used herein comprises code or machine readable instruction for implementing predetermined functions including those of an operating system, healthcare information system or other information processing system, for example, in response to user command or input. A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A workstation comprises a terminal, display, PC, portable processing device or phone, for example and a server as used herein comprises a processing device, PC, laptop, notebook, PDA (Personal Digital Assistant, phone or other device.

In the FIG. 1 system, workstations 10 and 12 bidirectionally communicate on network 15 with a group of servers 20 (e.g., a Citirx compatible, or other server farm) including servers 1, 2 and 3. A user establishes a first (Primary) session of operation 21 of executable application 30 on server 1 of group of servers 20 following logon and entry of user identification information via workstation 10 and authentication of the entered user identification information. This first session 21 is a Primary session of operation meaning the first session established by the user on server group 20. A Primary session is a semi-permanent session that is dragged from workstation to workstation as the user roams around a hospital or office, for example. Subsequently, a user starts to initiate a second (Attached) session of operation of executable application 30 via workstation 12. An Attached session is one currently displayed on a user's workstation. The Primary and Attached sessions may or may not be the same session. An executable procedure (such as a Script) is executed on server 1 (or another server or on a workstation in another embodiment) to advantageously make Primary and Attached sessions of operation one and the same sessions if they are initially different separate sessions. That is, if the session Attached to a user's workstation is not the Primary session of operation, an executable application 17 procedure is executed on server 1 to make them a single Primary session of operation and to eliminate other sessions. Individual servers of group 20 include an interface for bidirectionally communicating with workstations 10 and 12 and for receiving requests to initiate a current session of operation of a particular executable application as well as for receiving user identification information from a particular user.

A user that logs on to initiate a session of operation on a server of server group 20 for a first time and for which no orphaned sessions (active or disconnected) exist anywhere in group 20, initiates execution of a script procedure which creates a Primary session of operation of an executable application on the server connected to the current user workstation. Application 17 enables a session to follow the user as the user roams from PC to PC whilst supporting load balancing among the servers of group 20 to distribute user load relatively evenly across the servers of group 20. A user that logs on and re-connects to server group 20 and for which an existing Primary session in a disconnected state exists on one of the servers of group 20, initiates re-connection of a current workstation to the server running the previous disconnected session.

In one scenario, a second (Attached) session of operation of executable application 30 on server 1 that is initiated by the user via workstation 12, coincidentally re-connects to server 1 of server group 20. Therefore both the first (Primary) session of operation 21 of executable application 30 which is still active and the second (Attached) session of operation 22 of application 30 of the user, are connected to the same server (server 1). Session management application 17 including a script procedure (e.g., a session processor compatible with a Citrix server product or other proprietary server management system, for example) executes on server 1 (or another server or on a workstation in another embodiment). The script procedure of application 17 executes in response to user logon to initiate a session of operation of application 30 and entry of user identification information via a workstation.

The script procedure of application 17 makes Primary and Attached sessions of operation one and the same sessions if they are initially different separate sessions. Specifically, in response to the user's second login via workstation 12, the application 17 script procedure initiates a search of session tracking information maintained on server 1. The search identifies the active first (Primary) session of operation 21 of executable application 30 on server 1 that was previously initiated via workstation 10 and is associated with the user. The search of session tracking information maintained on server 1 is performed in response to received user identification information. The session tracking information is maintained on server 1 for the servers of group 20 and indicates active and disconnected sessions for different users and different applications for sessions of operation supported by the servers of group 20.

In another embodiment, the session tracking information may be maintained in another server of group 20 in a central repository or within multiple locations (e.g., by individual servers of group 20) or in another processing device such as a workstation connected to network 15. In a further embodiment, the application 17 script procedure may acquire session tracking information by deriving and compiling session tracking information from session associated status information acquired from one or more session manager applications (such as application 17) employed by server group 20. The status information indicates operation sessions still present on an individual server and is aquired by interrogating session operation history information retained by an individual server, for example. A session manager application manages opening of sessions and generation of unique session identifiers and associated user authentication operations for individual sessions supported by servers of group 20.

The application 17 script procedure identifies the active first (Primary) session of operation 21 of executable application 30 on server 1 that was previously initiated by the user via a workstation 10. This is done through search of session tracking information maintained on server 1 indicating operation sessions still present on server 1 that are associated with the previously entered user identification. The application 17 script procedure detaches the connection between workstation 10 and the active first (Primary) session of operation 21 of application 30 on server 1 by one or more of, disabling a communication link, disabling an association or mapping supporting communication and disabling a link supporting communication.

The application 17 script procedure re-attaches the connection of the detached active first (Primary) session of operation 21 to workstation 12 as the current second (Attached) session of operation 22 of executable application 30 without requiring re-authentication of received user identification information. In one Citrix server management system compatible embodiment, the application 17 script procedure automatically initiates a Citrix server pass-through client on the server running the current second (Attached) session 22. The Citrix server pass-through client re-attaches the connection of the detached active first (Primary) session of operation to workstation 12 as the current second (Attached) session without requiring a user to re-authenticate during the second connection. The re-attached session of operation continues at a position in an executable application comprising the active first (Primary) session of operation 21 where the user discontinued using this executable application. The application 17 script procedure re-attaches the connection by one or more of, enabling a communication link, establishing an association or mapping supporting communication and establishing a link supporting communication. The application 17 script procedure terminates sessions of operation on server 1 that are associated with the user, other than the re-attached detached active first (Primary) session of operation.

A user wearing RFID tag 25 (or another wireless technology identification tag or device) and roaming within a predetermined distance of workstation 10 (four feet, for example) activates an RFID sensor in RFID processor 24 in workstation 10. The RFID tag conveys user identification information, or information enabling derivation of user identification, to RFID processor 24. Thereby, RFID processor 24 enables a user to automatically log-on to workstation 10 without entering a password or userid in response to proximity detection by workstation 10. The RFID tag may itself incorporate, in one embodiment, a biometric sensor so that it is activatable by a particular user. In response to detection of RFID tag 25 within a predetermined distance of workstation 10, RFID processor 24 using workstation 10 and application 17, automatically initiates transfer of a user Primary (active or disconnected) session involving one or more executable applications from another workstation at a different location to workstation 10 ready for access by the user. For this purpose workstation 10 includes an interface for generating a request message for communication to a remote server (e.g., server 1) for initiating a current session of operation of a particular executable application on workstation 10 (a processing device) by transferring an identified session of operation of the user previously initiated via workstation 12 to workstation 10 as the current session of operation. A processing device as used herein comprises a workstation, PC, laptop, notebook, PDA (Personal Digital Assistant, phone or other device. When the user leaves the predetermined vicinity of workstation 10 application 17 suspends and secures the initiated session ready for re-activation or movement to another workstation and location.

In a further scenario, a user establishes a first (Primary) session of operation 21 of executable application 30 on server 1 of group of servers 20 following logon and entry of user identification information via workstation 10 and authentication of the entered user identification information. Another (Attached) session of operation of executable application (session 23) on server 2 of server group 20 is initiated by the user via workstation 12. The first (Primary) session of operation 21 of executable application 30 which is still active and (Attached) session 23 of operation of application 30 of the user, are connected to different servers, server 1 and server 2 respectively. In response to the user's second login via workstation 12, the application 17 script procedure initiates a search of session tracking information for the servers of group 20 maintained on server 1 (or on another server or distributed among the servers of group 20).

The application 17 script procedure search identifies the active first (Primary) session of operation 21 of executable application 30 on server 1 associated with the user that was previously initiated by the user via workstation 10. The search comprises a search of session tracking information maintained on server 1. The application 17 script procedure detaches the connection between workstation 10 and the active first (Primary) session of operation 21 of application 30 on server 1 and re-attaches the connection of the detached active first (Primary) session of operation to workstation 12 as the current second (Attached) session of operation 23 of executable application 30. The application 17 script procedure terminates sessions of operation that are associated with the user and are present on servers of group 20, other than the re-attached detached active first (Primary) session of operation. The system of FIG. 1 allows load balancing to be performed on the servers of group 20 as normal.

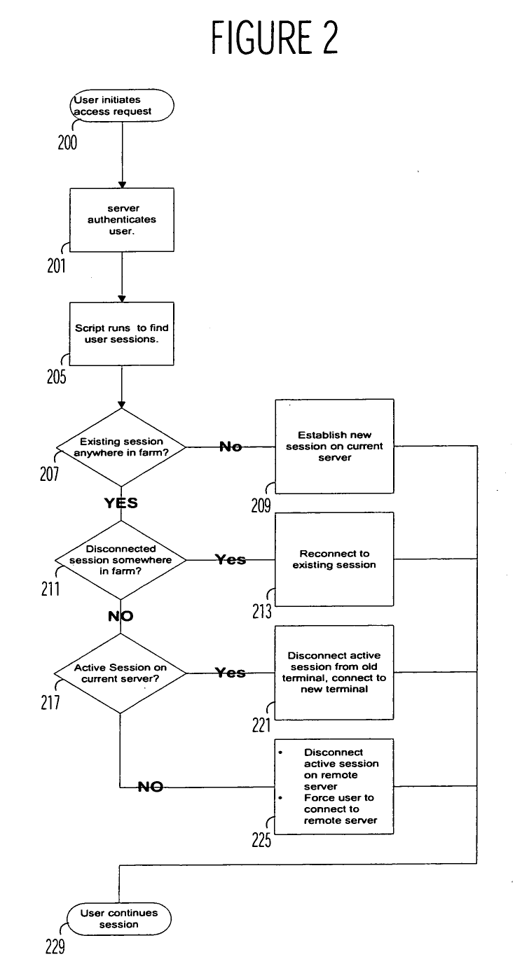

FIG. 2 shows a flowchart of a process used in the system of FIG. 1 for managing user operation sessions on one or more different servers. In response to a user initiating a request to access an application and receiving user identification information in step 200, an authentication procedure (such as a Citrix compatible procedure) executes in step 201 to determine whether the user is authorized to access the requested application. In step 205, the application 17 script procedure executes to interrogate servers of group 20 to determine if the user has any other existing sessions in server group 20. If the application 17 script procedure determines in step 207 that there are no other sessions anywhere in server group 20 for this user, a new session of operation is created on the current server and the user continues with the created session in step 229. If the application 17 script procedure determines in step 207 that there is at least one other session for this user on a server in server group 20, the script procedure determines in step 211 whether there is a disconnected session for this user on a server in server group 20. In response to detection of a disconnected session in step 211, the application 17 script procedure in step 213 re-attaches connection to the disconnected session and the user continues with this session in step 229.

If the application 17 script procedure determines in step 211 that there is no disconnected session for this user on a server in server group 20, the script procedure determines in step 217 whether there is an active session for this user on a current server (of server group 20) to which a user workstation is connected. A current server is a server to which a workstation currently employed by a user is connected. In response to detection in step 217 of an active session on a current server (of server group 20) to which a previously employed user workstation is connected, the application 17 script procedure in step 221 detaches the connection between the active session on the current server and the previously employed workstation to which it is connected. The application 17 script procedure re-attaches connection of a workstation currently employed by the user to the now disconnected active session on the current server and the user continues with this session in step 229. In response to no active session being detected on a current server (of server group 20) in step 217, the application 17 script procedure in step 225 detaches a connection between an active session on a remote (non-current) server and a workstation previously employed by the user to which the session is connected. The application 17 script procedure re-attaches connection of a workstation currently employed by the user to the now disconnected active session on the remote server and the user continues with this session in step 229.

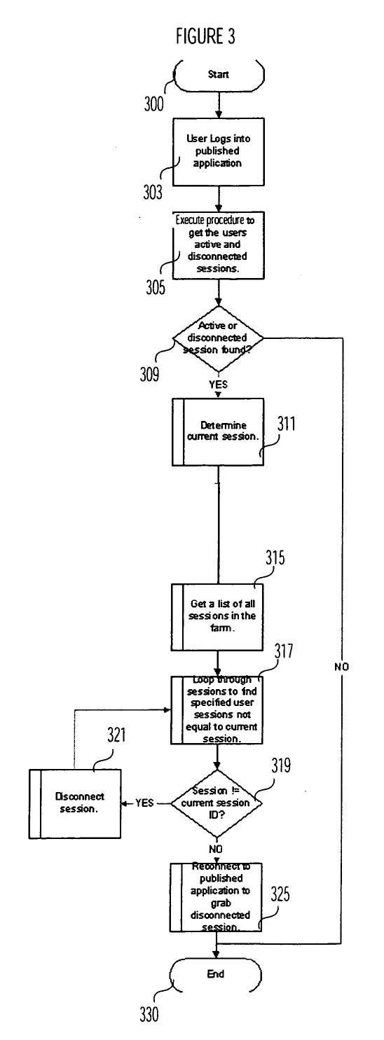

FIG. 3 shows a flowchart of a process used in the system of FIG. 1 to identify and re-connect to previous user operation sessions. A user logs on to an executable application such as application 30 (FIG. 1) in step 303, following the start at step 300. In step 305 in response to user logon, a script procedure such as the application 17 script procedure executes to identify active and disconnected sessions of operation of the user present on servers in server group 20. If the application 17 script procedure determines in step 309 that there are no active or disconnected sessions of operation of the user present on servers in server group 20, the process terminates at step 330. If the application 17 script procedure determines in step 309 that there are active or disconnected sessions of operation of the user present on servers in server group 20, the application 17 script procedure obtains a session identifier of a current session of operation of an application in step 311. The current session is hosted by a current server to which a workstation currently employed by a user is connected.

The application 17 script procedure in step 315 obtains data identifying the sessions of operation present on the servers of group 20. In steps 317, 319 and 321 the application 17 script procedure disconnects the sessions identified in step 315 having session identifiers different to the session identifier of the current session previously obtained in step 311. The sessions disconnected in steps 317, 319 and 321 are disconnected without user performance of a workstation logout function. The application 17 script procedure in step 325 re-attaches the connection of a session of operation disconnected in step 321 to the current user workstation in response to user logon in step 303. The process of FIG. 3 terminates at step 330.

The systems and processes presented in FIGS. 1-3 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system according to invention principles is usable wherever users roam from device to device and it is advantageous for the user to return to a previous image page or location within an executable application. Further, any of the functions provided by the application 17 script procedure of FIG. 1 may be implemented in hardware, software or a combination of both and may reside on one or more processing devices located at any location of a network linking the FIG. 1 elements or another linked network including another intra-net or the Internet.

1. A system for managing user operation sessions on a plurality of servers, comprising:
an interface for receiving, from a first workstation, a request to initiate a current session of operation of a particular executable application on a first server and user identification information from a particular user; and
a session processor for, in response to said received particular user identification information,
identifying an active session of operation of said particular user on a second server previously initiated via a second workstation and
re-attaching connection of said previously initiated active session of operation to said first workstation as said current session.

2. A system according to claim 1, wherein
said session processor re-attaches connection of said previously initiated active session of operation to said first workstation as said current session without requiring re-authentication of said particular user identification information.

3. A system according to claim 1, wherein
said request to initiate a current session of operation is generated in response to wireless detection of a remote tag within a predetermined proximity of said first workstation.

4. A system for managing user operation sessions on a server, comprising:
an interface for receiving, from a first workstation, a request to initiate a current session of operation of a particular executable application on a first server and user identification information from a particular user; and
a session processor for, in response to said received particular user identification information,
identifying an active session of operation of said particular user on said first server previously initiated via a second workstation,
detaching connection of said identified previously initiated active session of operation to said second workstation and
re-attaching connection of said detached previously initiated active session of operation to said first workstation as said current session.

5. A system according to claim 4, wherein
said step of detaching connection comprises at least one of, (a) disabling a communication link, (b) disabling an association or mapping supporting communication and (c) disabling a link supporting communication.

6. A system according to claim 4, wherein
said step of re-attaching connection comprises at least one of, (a) enabling a communication link, (b) establishing an association or mapping supporting communication and (c) establishing a link supporting communication.

7. A system according to claim 4, wherein
said first and second workstations are different workstations and
said session processor re-attaches connection of said current session to said detached previously initiated active session of operation of an executable application at a position in said executable application where said particular user discontinued using said executable application.

8. A system according to claim 4, wherein
a session of operation comprises at least one of, (a) a session of operation of an executable application and (b) a session of operation of a processing device.

9. A system according to claim 8, wherein
said session of operation of a processing device comprises at least one of, (i) a session of operation of a workstation and (ii) a session of operation of a server.

10. A system according to claim 4, wherein
said session processor detaches connection of said identified previously initiated active session of operation to said second workstation without user performance of a second workstation logout function.

11. A system according to claim 4, wherein
said session processor identifies said active session of operation on said first server by acquiring information indicating operation sessions still present on said first server and associated with said user identification information from said particular user.

12. A system according to claim 4, wherein
said session processor acquires status information indicating operation sessions still present on said first server by interrogating session operation history information on said first server.

13. A system according to claim 4, wherein
said session processor terminates sessions of operation, associated with said particular user on said first server, other than said re-attached detached previously initiated active session.

14. A system according to claim 4, wherein
said session processor is compatible with a Citrix server product.

15. A system according to claim 4, wherein
said session processor re-attaches connection of said detached previously initiated active session of operation to said first workstation as said current session without requiring re-authentication of said particular user identification information.

16. A system according to claim 4, wherein
said request to initiate a current session of operation is generated in response to wireless detection of a remote tag within a predetermined proximity of said first workstation.

17. A system for managing user operation sessions on a plurality of servers, comprising:
an interface for receiving, from a first workstation, a request to initiate a current session of operation of a particular executable application on a first server and user identification information from a particular user; and
a session processor for, in response to said received particular user identification information,
identifying an active session of operation of said particular user on a second server previously initiated via a second workstation,
detaching connection of said identified previously initiated active session of operation to said second workstation and
re-attaching connection of said detached previously initiated active session of operation to said first workstation as said current session.

18. A system according to claim 17, wherein
said session processor re-attaches connection of said detached previously initiated active session of operation to said first workstation as said current session without requiring re-authentication of said particular user identification

19. A system according to claim 17, wherein
said first and second workstations are different workstations and
said first and second servers are different servers.

20. A system according to claim 17, wherein
said session processor acquires status information indicating operation sessions still present on said plurality of servers by interrogating said plurality of servers.

21. A system according to claim 17, wherein
said session processor terminates sessions of operation, associated with said particular user on said first and second servers, other then said re-attached detached previously initiated active session

22. A system according to claim 17, wherein
said session processor is compatible with at least one of, (a) a Citrix server management system, (b) a Microsoft server management systemand (c) an open source compatible server management system.

23 A system according to claim 17, wherein
said session processor detaches connection of said identified previously initiated active session of operation to said second workstation without user performance of a second workstation logout function.

24. A system for acquiring a user operation session by a processing device, comprising:
a proximity detector for wirelessly detecting presence of a remote tag substantially within a predetermined distance of a first processing device, said remote tag being associated with a particular user; and
an interface for generating a request message for communication to a remote device for initiating a current session of operation of a particular executable application on said first processing device by transferring an identified session of operation of said particular user previously initiated via a second processing device to said first processing device as said current session of operation.

25. A system according to claim 24, wherein
said remote tag is an RFID tag and
said proximity detector comprises an RFID processor for detecting an RFID tag.

26. A system according to claim 24, wherein
said identified session of operation is an active session.

27. A system according to claim 24, wherein
said request message initiates,
identifying said session of operation of said particular user previously initiated via a second processing device, and
re-attaching connection of said previously initiated session of operation to said first processing device as said current session of operation.

28. A method for managing user operation sessions on a plurality of servers, comprising the activities:
receiving, from a first workstation, a request to initiate a current session of operation of a particular executable application on a first server and user identification information from a particular user; and
in response to said received particular user identification information,
identifying an active session of operation of said particular user on a second server previously initiated via a second workstation and
re-attaching connection of said previously initiated active session of operation to said first workstation as said current session.

29. A method according to claim 28 including the activity of
detaching connection of said identified previously initiated active session of operation to said second workstation prior to re-attaching connection of a detached previously initiated active session of operation to said first workstation as said current session
